(19) United States
(12) Patent Application Publication
(10) Pub. No.: US 2009/0025589 A1
(43) Pub. Date: Jan. 29, 2009

(54) Support for Printing Material and Printing Plate Material

(76) Inventor: Takahiro Mori, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/086,823

(22) PCT Filed: Dec. 12, 2006
(86) PCT No.: PCT/JP2006/324729

§ 371 Date: Jun. 19, 2008

(30) Foreign Application Priority Data
Dec. 26, 2005 (JP) 2005-371691

(51) Int. Cl. B41N 1/14

(52) U.S. Cl. 101/395

(57) ABSTRACT

In the present invention, disclosed is a support for a printing plate material possessing an aluminum plate having been subjected to at least a surface-roughening treatment and an anodizing treatment, wherein the support has a roughened surface having a center-line average roughness Ra of from 0.25 μm to 0.50 μm, and a skewness Rsk of from −0.8 to 0, and an objective is to provide a support for a printing plate material exhibiting excellent resistance to blanket contamination with no deterioration of printing ability, and also to provide a printing plate material exhibiting excellent resistance to blanket contamination, even though the support is employed for an on-press development type printing plate material.

### TECHNICAL FIELD

The present invention relates to a support for a printing plate material and the printing plate material, and particularly to a support for a printing plate material capable of forming an image according to a computer to plate (CTP) system.

### BACKGROUND

Generally, aluminum or an aluminum alloy constituting a support for a printing plate material is subjected to a degreasing treatment, a surface-roughening treatment, an anodizing treatment and a hydrophilization treatment to produce the support. Various studies aiming at improving various properties of performance during printing have been done, since a fine roughened profile in the order of from several tens nano meters to several micro meters can be adjusted by controlling each of these treatment conditions.

As the performance during printing associated with a surface profile of a support for a printing plate material, resistance to blanket contamination is provided. The blanket contamination means a phenomenon in which ink adheres slightly to non-image portions on the support surface onto which ink is not allowed basically to adhere, and ink is deposited on the blanket surface little by little. Since blanket contamination produces degradation of image quality, background contamination and so forth, the printing operation has to be interrupted for blanket cleaning when the contamination is heavily produced. In cases where a support which is easy to produce blanket contamination is used, blanket cleaning is desired to be frequently conducted so that productivity of a printing operation is largely deteriorated, whereby a support exhibiting resistance to blanket contamination has been demanded.

It is pointed out that blanket contamination is largely influenced by a protrusion profile of a support, and various ideas are disclosed in order to improve the blanket contamination (refer to Patent Documents 1 and 2), but the improvement level has still been insufficient.

On the other hand, in the field of printing, a processless printing plate material has been sought, which is not desired to conduct a development treatment employing specific chemicals. As the processless printing plate material, a so-called on-press development type printing plate material with which unexposed portions of an image formation layer are removed on a printing press employing dampening water and ink can be provided.

The on-press development type printing plate material contains a microcapsule encapsulating thermoplastic hydrophobic resin particles and a hydrophobic compound as a hydrophobic precursor capable of forming an image with heat generated via exposure to infrared laser, on an image formation layer.

However, after considerable effort during intensive studies, the inventor has found out that in the case of the on-press development type printing plate material, the microcapsule encapsulating such the thermoplastic hydrophobic resin particles and the hydrophobic compound is forced and adheres onto the blanket surface, and this contributes to blanket contamination.

In cases where the microcapsule encapsulating such the thermoplastic hydrophobic resin particles and the hydrophobic compound is forced and adheres onto the blanket surface, it is also found out that blanket contamination is largely influenced by a protrusion profile of the support surface. Such the generated phenomenon has not been predicted at all in the past, and studies to improve blanket contamination in the case of the on-press development type printing plate material have not been done at all.

Concerning the above-described, the inventor has come up with the present invention via studies on the support surface profile exhibiting excellent resistance to blanket contamination, which is suitable for the on-press development type printing plate material.

Patent Document 1: Japanese Patent O.P.I. Publication No. 2002-2142

Patent Document 2: Japanese Patent O.P.I. Publication No. 2004-299244

### DISCLOSURE OF THE INVENTION

### Problems to be Solved by the Invention

The present invention has been made on the basis of the above-described situation, and it is an object of the present invention to provide a support for a printing plate material exhibiting excellent resistance to blanket contamination with no deterioration of printing ability, and also to provide a printing plate material exhibiting excellent resistance to blanket contamination, even though the support is employed for an on-press development type printing plate material.

### Means to Solve the Problems

The object of the present invention is accomplished by the following structures.

(Structure 1) A support for a printing plate material comprising an aluminum plate having been subjected to at least a surface-roughening treatment and an anodizing treatment, wherein the support has a roughened surface having a center-line average roughness Ra of from 0.25 μm to 0.50 μm, and a skewness Rsk of from −0.8 to 0.

(Structure 2) A printing plate material comprising a support and provided thereon, an on-press developable image formation layer, wherein the support comprising an aluminum plate having been subjected to at least a surface-roughening treatment and an anodizing treatment has a roughened surface having a center-line average roughness Ra of from 0.25 μm to 0.50 μm, and a skewness Rsk of from −0.8 to 0.

(Structure 3) The printing plate material of Structure 2, wherein the on-press developable image formation layer comprises an oleophilic polymer particle or a microcapsule encapsulating an oleophilic material.

### EFFECT OF THE INVENTION

In the present invention, provided is a support for a printing plate material exhibiting excellent resistance to blanket contamination, together with excellent printing ability such as printing durability, water retention latitude and so forth, and also to provide a printing plate material exhibiting excellent resistance to blanket contamination, even though the support is employed for an on-press development type printing plate material.

### DESCRIPTION OF THE PREFERRED EMBODIMENTS

The preferred embodiments of the present invention will be explained below, but the present invention is not limited thereto.

The present invention has a feature of a support for a printing plate material comprising an aluminum plate having been subjected to at least a surface-roughening treatment and an anodizing treatment, wherein the support has a roughened surface having a center-line average roughness Ra of from 0.25 μm to 0.50 μm, and a skewness Rsk of from −0.8 to 0.

Surface roughness parameters (Ra and Rsk) of the support in the present invention are measured employing a three dimensional surface roughness measuring device with a resolution of 1 μm or less.

Ra and Rsk in the present invention are defined according to ISO4287.

That is, Ra (μm) is referred to as the value obtained via the following equation, when the region of measure value lr is extracted in the center-line direction from the roughness curve, and X-axis in this extracted region and Y-axis in the direction of longitudinal magnification are represented by y=Z(x).

$$Ra = \frac{1}{Ir} {\int }_{0}^{Ir} \vert Z ( x ) \vert d x$$

Rsk is referred to as the value obtained via the following equation.

$$Rsk = \frac{1}{{Rq}^{3}} [ \frac{1}{Ir} {\int }_{0}^{Ir} {Z}^{3} ( x ) d x ]$$

$$Rq = \sqrt{\frac{1}{Ir} {\int }_{0}^{Ir} {Z}^{2} ( x ) d x}$$

A non-contact three dimensional fine surface profile measuring device RSTPLUS, produced by WYKO Co., Ltd. can be utilized as a measuring device by which the roughness curve can be measured.

Herein, Rsk (skewness) as a parameter of surface roughness means a measure indicating how much height distribution of the surface is deviated from the normal distribution, and the height distribution is close to the normal distribution when the value of Rsk is 0. As a model surface, in cases where protrusions are formed on the smooth surface, the value of Rsk becomes positive, and in cases where concaves are formed on the smooth-surface, the value of Rsk becomes negative.

As for the measurement of a roughness curve, measurements are conducted at a magnification of 40 times, employing a non-contact three dimensional surface roughness measuring device RST plus produced by WYKO Co., Ltd., (in which the measurement area is 111.2 μm×149.7 μm, the measuring point is 236×368, and the resolution indicates a size of 0.47 μm×0.41 μm at one measuring point). The resulting measurement is subjected to slope correction and to filtering treatment of Median Smoothing to obtain an Ra value and an Rsk value. Five portions are measured, and the average of the measurements is taken to determine the Ra value and the Rsk value.

When the height distribution of a surface roughness profile is a normal distribution centering on the roughness center-line, Rsk becomes 0.

The Rsk range of the present invention which is an Rsk of from −0.8 to 0 means that excessive protrusions are not present on the surface, that is, a probability of existing excessively high protrusions is low, or a density of existing protrusions is not excessively high, and also means that the height distribution of a roughness profile is a surface profile close to the normal distribution, that is, a probability of existing excessively deep concaves is low.

The surface roughness of a support is designed to be an appropriate surface profile in which a probability of existing excessively high protrusions, to which ink possibly adheres, is low, or a density of existing protrusions is not excessively high, whereby resistance to blanket contamination becomes possible to be largely improved.

In the case of Rsk exceeding 0, resistance to blanket contamination is degraded since protrusions to which ink easily adheres increase.

On the other hand, in the case of less than −0.8, a profile in which concaves are scattered in the smooth region where the support surface profile exists as a continuous phase, but resistance to blanket contamination is still degraded. The mechanism in this case is unclear, but it is assumed that in the case of such the profile, ink adheres to the entire smooth region.

In the case of Ra exceeding 0.5 μm, increase of the protrusion height caused by increase of the whole roughness is observed, whereby resistance to blanket contamination is degraded.

In the case of Ra less than 0.25 μm, a water retention property with a printing plate and printing durability tend to be deteriorated, though resistance to blanket contamination is not degraded.

Further in the present invention, disclosed is a printing plate material comprising a support and provided thereon, an on-press developable image formation layer, wherein the support possessing an aluminum plate having been subjected to at least a surface-roughening treatment and an anodizing treatment has a roughened surface having a center-line average roughness Ra of from 0.25 μm to 0.50 μm, and a skewness Rsk of from −0.8 to 0.

As the on-press developable image formation layer in the printing plate material of the present invention, an image formation layer preferably contains oleophilic polymer particles or a microcapsule encapsulating an oleophilic material.

An on-press developable image formation layer of the present invention means an image formation layer with which the image formation layer at portions where non-image portions are formed during printing is removed with dampening water, or dampening water and printing ink at the stage where a printing process is carried out via no specific developing process after imagewise exposure, that is, at the stage for printing preparation where the layer is placed on a planographic printing press, and a printable image is possible to be formed.

In the case of a printing plate material possessing an on-press developable image formation layer, the printing plate is brought into contact with the blanket while having an image formation layer at non-image portions at the initial stage of printing. In this case, the image formation layer contains an oleophilic material in no small measure as an ink receptivity component, and it is assumed that produced is a situation in which such the oleophilic material is forced on the blanket surface by protrusions on the support surface.

In such a presumed mechanism concerning the printing plate material possessing an on-press developable image formation layer, it is assumed that resistance to blanket contamination is largely influenced by the support surface profile.

Specifically, a structure, in which the image formation layer contains oleophilic polymer particles or a microcapsule encapsulating an oleophilic material, possesses a property in which the particles are easy to be fixed onto the blanket surface by squashing the particles by protrusions on the support surface during being forced onto the blanket surface, and another property in which an oleophilic inclusion material is easy to be fixed onto the surface via squashing of the microcapsule, and setting the support surface profile in the range of roughness parameters of the present invention is largely effective in reducing blanket contamination.

### [Support]

Aluminum supports utilized for a support for a printing plate of the present invention include a support made of pure aluminum or an aluminum alloy. As the aluminum alloy, there can be used various ones including an alloy of aluminum and a metal such as silicon, copper, manganese, magnesium, chromium, zinc, lead, bismuth, nickel, titanium, sodium or iron.

It is preferable that the aluminum support is subjected to a degreasing treatment for removing rolling oil on the aluminum surface prior to surface roughening. The degreasing treatments include a degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone.

When an aqueous alkali solution such as caustic soda or the like is used for the degreasing treatment, the resulting support is preferably immersed in an acid such as phosphoric acid, nitric acid, sulfuric acid, chromic acid, or a mixed acid thereof to be subjected to a neutralization treatment. When electrochemical surface-roughening is carried out after the neutralization treatment, the acid employed for neutralization is preferably adopted to an acid used for electrochemical surface-roughening.

Though electrolytic surface-roughening with a method of the present invention is carried out for surface-roughening of a support, surface-roughening appropriately in combination with chemical surface-roughening and mechanical surface-roughening as a pretreatment may be carried out for an appropriate treatment amount.

Similarly to the degreasing treatment, an aqueous alkali solution such as caustic soda or the like is used for chemical surface-roughening. The support is preferably immersed in an acid such as phosphoric acid, nitric acid, sulfuric acid, chromic acid, or a mixed acid thereof to be subjected to a neutralization treatment after the treatment. When electrochemical surface-roughening is carried out after the neutralization treatment, the acid employed for neutralization is preferably adopted to an acid used for electrochemical surface-roughening.

Though there is no restriction for the mechanical surface-roughening treatment, a brushing roughening method and a honing roughening method can be provided. In order to acquire the profile of the present invention, it is preferable that the mechanical surface-roughening treatment is not conducted, or is slightly conducted, if any.

In the case of the brushing roughening method, a cylindrical brush with a brush hair having a diameter of 0.2-1 mm, for example, is rotated, and pressed onto the support surface while supplying slurry in which abrasives are dispersed onto the contact surface with water to conduct a surface-roughening treatment.

In the case of the honing roughening method, the slurry in which abrasives are dispersed in water is sprayed from a nozzle via application of pressure, and is collided with the support surface from an angle to conduct a surface-roughening treatment.

As abrasives, volcanic ash, alumina, silicon carbide and so forth are commonly employed for roughening, and the graininess is #200-#2000, and preferably #400-#800.

In order to remove abrasives, aluminum dust and so forth cut deep into the support surface, and to control the pit geometry, the mechanically surface-roughened support is preferably immersed in an acid or an aqueous alkali solution to conduct etching. Examples of the acid include sulfuric acid, persulfuric acid, hydrofluoric acid, phosphoric acid, nitric acid and hydrochloric acid, and examples of the alkali include sodium hydroxide and potassium hydroxide. Of these, the aqueous alkali solution is preferably employed.

When the support is immersed in an aqueous alkali solution, it is preferable for the support to be dipped in an acid such as phosphoric acid, nitric acid, sulfuric acid and chromic acid, or in a mixed acid thereof, for neutralization.

When electrochemical surface-roughening is carried out after the neutralization treatment, it is particularly preferable that the acid employed for neutralization is adopted to an acid used for electrochemical surface-roughening. Further, when an anodizing treatment is carried out after the neutralization treatment, it is particularly preferable that the acid employed for neutralization is adopted to an acid used for the anodizing treatment.

Electrochemical surface-roughening is generally surface-roughening in an acidic electrolytic solution employing alternating current. A solution conventionally employed for electrochemical surface-roughening is utilized for the acidic electrolytic solution, but a hydrochloric acid based electrolytic solution or a nitric acid based electrolytic solution is preferable, and it is particularly preferable that a hydrochloric acid based electrolytic solution is utilized for divided electrolytic treatments.

As power supply waveforms employed for electrolysis, various waveforms such as a rectangular wave form, a trapezoidal waveform, a sawtooth waveform and so forth are usable, but a sine wave is particularly preferable.

Voltage applied in the electrochemical surface-roughening treatment employing a nitric acid based electrolytic solution is preferably 1-50 V, and more preferably 5-30 V. The current density (in terms of peak value) employed here is preferably 10-200 A/dm², and more preferably 20-150 A/dm².

The total quantity of electricity is preferably 100-2000 C/dm², more preferably 200-1500 C/dm², and most preferably 200-1000 C/dm².

Temperature during the treatment is preferably 10-50° C., and more preferably 15-45° C. A nitric acid concentration of 0.1-5% by weight is preferable.

Nitrate, chloride, amines, aldehydes, a phosphoric acid, a chromic acid, a boric acid, an acetic acid or an oxalic acid can be added into the electrolytic solution, if desired.

In the electrochemical surface roughening treatment carried out employing a hydrochloric acid based electrolytic solution, voltage applied is preferably 1-50 V, and more preferably 5-30 V. The current density (in terms of peak value) used is preferably 10-200 A/dm², and more preferably 20-150 A/dm². The total quantity of electricity is preferably 100-2000 C/dm², and more preferably 200-1000 C/dm². Temperature during the treatment is preferably 10-50° C., and more preferably 15-45° C. A hydrochloric acid concentration of 0.1-5% by weight is preferable.

Nitrate, chloride, amines, aldehydes, a phosphoric acid, a chromic acid, a boric acid, an acetic acid or an oxalic acid can be added into the electrolytic solution, if desired.

Preferably usable is a method of conducting an electrochemical surface-roughening treatment which is divided into a plurality of treatments, as described in Japanese Patent O.P.I. Publication No. 10-869.

The electrochemically surface-roughened support is preferably immersed in an aqueous acid or alkali solution in order to remove smut produced on the support surface, or to control the shape of pits formed on the support surface, whereby the surface is etched.

Examples of the acid include sulfuric acid, persulfuric acid, hydrofluoric acid, phosphoric acid, nitric acid and hydrochloric acid, and examples of the alkali include sodium hydroxide and potassium hydroxide. Of these, the aqueous alkali solution is preferably employed. When the support is immersed in an aqueous alkali solution, it is preferable for the support to be dipped in an acid such as phosphoric acid, nitric acid, sulfuric acid and chromic acid, or in a mixed acid thereof, for neutralization. When an anodizing treatment is carried out after the neutralization treatment, it is particularly preferable that the acid employed for neutralization is adopted to an acid used for the anodizing treatment.

A surface-roughening treatment followed by an anodizing treatment is carried out, and subsequently, a sealing treatment and a hydrophilization treatment are conducted.

The method of conducting an anodizing treatment of the present invention is not specifically limited, and a commonly known method is utilized. The anodizing treatment forms an oxidized film on a support. For the anodizing treatment in the present invention, there is preferably used a method of applying a current density of 1-10 A/dm² to an aqueous solution containing sulfuric acid and/or phosphoric acid in a concentration of 10-50%, as an electrolytic solution. However, it is also possible to use a method of applying a high current density to sulfuric acid as described in U.S. Pat. No. 1,412,768, and a method to electrolytically etching the support in phosphoric acid as described in U.S. Pat. No. 3,511,661.

The support, which has been subjected to an anodizing treatment, is optionally subjected to a sealing treatment. For the sealing treatment, it is possible to use known methods using hot water, boiling water, steam, a sodium silicate solution, an aqueous dichromate solution, a nitrite solution and an ammonium acetate solution.

In order to set a surface profile of the support in the range of the present invention (a center-line average roughness Ra of from 0.25 μm to 0.50 μm, and a skewness Rsk of from −0.8 to 0), an electrochemical surface-roughening treatment is preferably carried out employing an electrolytic solution containing a hydrochloric acid and aluminum, or containing aluminum and an organic acid such as a hydrochloric acid, an acetic acid or the like.

Specifically, in a method of conducting an electrochemical surface-roughening treatment which is divided into a plurality of treatments, as described in Japanese Patent O.P.I. Publication No. 10-869 after the current density (in terms of peak value) during electrolysis is set to 40-120 A/dm², it is preferable that quantity of electricity for conducting the electrochemical surface-roughening treatment once is set to 40-80 C/dm², and the total quantity of electricity is set to 200-600 C/dm².

### [Image Formation Layer]

The image formation layer is not specifically limited, a commonly known negative working image formation layer and positive working image formation layer are usable. These may be a type developed with an aqueous alkali solution, a type developed with a near-neutral aqueous solution having roughly a pH of 5-10, and a type referred to as a so-called on-press developable type developed on a printing press with dampening water and ink.

In cases where an on-press developable image formation layer is specifically employed in the present invention as described before, an effect exhibiting reduction of blanket contamination is largely produced.

An image formation layer containing a polymerizable compound described in Japanese Patent O.P.I. Publication Nos. 2005-59445 and 2005-186300, for example, as the on-press developable image formation layer.

Further, the image formation layer may be composed of a plurality of layers, and a subbing layer may be provided as described in Japanese Patent O.P.I. Publication Nos. 2005-7655 and 2605-119273.

As a preferred configuration of an image formation layer in the present invention, provided is a configuration in which the image formation layer contains a hydrophobe precursor.

As the hydrophobe precursor, used can be a polymer whose property is capable of changing from a hydrophilic property (a water dissolving property or a water swelling property) or to a hydrophobic property by heating. Examples of the hydrophobe precursor include a polymer having an aryldiazosulfonate unit as disclosed in for example, Japanese Patent O.P.I. Publication No. 2000-56449. However, in the present invention, preferably employed is a microcapsule encapsulating thermoplastic hydrophobic particles or a hydrophobic material.

As the thermoplastic hydrophobic particles, provided can be the after-mentioned heat melting particles or heat fusible particles.

The heat melting particles employed in the present invention are particularly particles having a low melt viscosity, which are those formed from materials generally classified into wax. The heat melting particles preferably have a softening point of 40-120° C. and a melting point of 60-150° C., and more preferably a softening point of 40-100° C. and a melting point of 60-120° C. The melting point less than 60° C. produces a problem in storage stability and the melting point exceeding 300° C. lowers ink receptive sensitivity.

Examples of the material usable in the heat melting particles include paraffin wax, polyolefin wax, polyethylene wax, microcrystalline wax, fatty acid based wax, and so forth. The molecular weight thereof is approximately 800-10,000. A polar group such as a hydroxyl group, an ester group, a carboxyl group, an aldehyde group and a peroxide group may be introduced into the wax via oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of a fatty acid amide thereof, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins are also usable.

Among them, polyethylene wax, microcrystalline wax, fatty acid ester, and fatty acid are preferably contained. High sensitive image formation can be performed since these materials each have a low melting point relatively and a low melt viscosity. These materials each have a lubrication ability. Accordingly, even when a shearing force is applied to the surface layer of the material, the layer damage is minimized, and resistance to stain which may be caused by scratch is further enhanced.

The heat melting particles are preferably dispersible in water. The average particle diameter thereof is preferably 0.01-10 μm, and more preferably 0.1-3 μm, in view of on-press developability and resolution.

Further, the composition of the heat melting particle may continuously vary from the surface layer to the inside, or the heat melting particle may be covered with a different material.

As a covering method, employed are a commonly known microcapsule formation method, a sol-gel method, and so forth.

The content of heat melting particles in an image formation layer is 1-90% by weight, and more preferably 5-80% by weight.

The heat fusible particles of the present invention include thermoplastic hydrophobic polymer particles. Although there is no specific limitation to the upper limit of the softening point of the hydrophobic polymer particles, the softening point is preferably lower than the decomposition temperature of the hydrophobic polymer particles. Weight average molecular weight (Mw) of the hydrophobic polymer is preferably within the range of 10,000-1,000,000.

Examples of the polymer constituting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

Further, the heat fusible particles are preferably dispersible in water, and the average particle diameter is preferably 0.01-10 μm, and more preferably 0.1-3 μm in view of on-press developability and resolution.

Further, the composition of the heat fusible particle may continuously vary from the surface layer to the inside, or the heat fusible particle may be covered with a different material.

As a covering method, employed are a commonly known microcapsule formation method, a sol-gel method, and so forth.

The content of thermoplastic particles in an image formation layer is 1-90% by weight, and more preferably 5-80% by weight.

Microcapsules employed in a printing plate material of the present invention include those encapsulating a hydrophobic material as disclosed in Japanese Patent O.P.I. Publication Nos. 2002-2135 and 2002-19317.

The microcapsules preferably have an average diameter of 0.1-10 μm, more preferably 0.3-5 μm, and still more preferably 0.5-3 μm. The thickness of the microcapsule wall is preferably 1/100-⅕ of the microcapsule diameter, and more preferably 1/50- 1/10 of the microcapsule size.

The content of the microcapsule in the entire image formation layer is preferably 5-100% by weight, more preferably 20-95% by weight, and still more preferably 40-90% by weight.

As the materials for the microcapsule wall, known materials can be used. As a method of manufacturing the microcapsules, known methods can be used. The materials for the microcapsule wall and the manufacturing method of the microcapsule wall can be applied which are disclosed in for example, Tamotsu Kondo, Masumi Koishi, “New Edition Microcapsule, Its Manufacturing Method, Properties And Application”, published by Sankyo Shuppan Co., Ltd., or disclosed in literatures cited in it.

### [Binder]

A water-soluble resin or a water-dispersible resin can be contained in the image formation layer. Examples of the water-soluble or the water-dispersible resin include oligosaccharide, polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, a polyacrylic acid, polyacrylate, polyacrylamide, polyvinyl pyrrolidone, and so forth.

Of these, oligosaccharide, polysaccharides, a polyacrylic acid, polyacrylate (sodium salt, etc.), and polyacrylamide are preferable.

Examples of the oligosaccharide include raffinose, trehalose, maltose, galactose, sucrose, lactose and so forth, but trehalose is specifically preferable.

Examples of the polysaccharides include starches, celluloses, a polyuronic acid, pullulan and so forth. Of these, cellulose derivatives such as a methyl cellulose salt, a carboxymethyl cellulose salt and a hydroxyethyl cellulose salt are preferred, and a sodium or an ammonium salt of carboxymethyl cellulose is more preferred.

The molecular weight of a polyacrylic acid, polyacrylate (sodium salt, etc.) and polyacrylamide each preferably has a molecular weight of 3,000-5,000,000, and more preferably has a molecular weight of 5,000-3,000,000.

### [Other Contained Materials]

The after-mentioned light-to-heat conversion material can be contained in the image formation layer. Since a part of the image formation layer is on-press-developed, a material or a dye exhibiting less coloring upon visible light is preferably employed.

A water-soluble surfactant may be contained in the image formation layer in the present invention. A silicon element-containing surfactant and a fluorine atom-containing surfactant can be used. The silicon element-containing surfactant is especially preferred in that it minimizes printing contamination. The content of the surfactant is preferably 0.01-3% by weight, and more preferably 0.03-1% by weight, based on the total weight of the hydrophilic layer (or the solid content in the case of the coating solution).

The image formation layer in the present invention may also contain an acid (a phosphoric acid or an acetic acid) or an alkali (sodium hydroxide, silicate, or phosphate) to adjust pH.

### [Light-to-Heat Conversion Material]

### [Dye]

Examples of the infrared absorbing dye include a conventional infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine based compound, a naphthalocyanine based compound, an azo based compound, a thioamide based compound, a dithiol based compound or an indoaniline based compound. Specific examples thereof include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be employed singly or in combination.

Further, compounds described in Japanese Patent O.P.I. Publication Nos. 11-240270, 11-265062, 2000-309174, 2002-49147, 2001-162965, 2002-144750, and 2001-219667 can be preferably employed.

### [Pigment]

Examples of the pigment include carbon, graphite, metal and metal oxide.

Furnace black and acetylene black are preferably used as the carbon. Graininess (d₅₀) thereof is preferably not more than 100 nm, and more preferably not more than 50 nm.

As the graphite, usable is one having a particle diameter of not more than 0.5 μm, preferably having a particle diameter of not more than 100 nm, and more preferably having a particle diameter of not more than 50 nm.

As the metal, any metal can be used as long as the metal is in a form of particles having a particle diameter of not more than 0.5 μm, preferably having a particle diameter of not more than 100 nm, and more preferably having a particle diameter of not more than 50 nm. The metal may have any shape such as spherical, flaky and needle-like. Colloidal metal particles such as those made of silver or gold are particularly preferred.

As the metal oxide, materials having black color in the visible regions or materials, which are conductive or semiconductive, can be used.

Examples of the former include black iron oxide and black composite metal oxides containing at least two kinds of metals.

Examples of the latter include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable. These have a particle diameter of not more than 0.5 μm, preferably have a particle diameter of not more than 100 nm, and more preferably have a particle diameter of not more than 50 nm.

As these light-to-heat conversion materials, black iron oxide or black composite metal oxides containing at least two kinds of metals are more preferred.

It is preferable that black iron oxide (Fe₃O₄) particles have an average particle diameter of 0.01-1 μm, and an acicular ratio (major axis length/minor axis length) of 1-1.5. It is preferable that the black iron oxide particles are substantially spherical ones (having an acicular ratio of 1) or octahedral ones (having an acicular ratio of 1.4).

Examples of the black iron oxide particles include TAROX series produced by Titan Kogyo K.K. Examples of the spherical particles include BL-100 (having a particle diameter of 0.2-0.6 μm), and BL-500 (having a particle diameter of 0.3-1.0 μm). Examples of the octahedral particles include ABL-203 (having a particle diameter of 0.4-0.5 μm), ABL-204 (having a particle diameter of 0.3-0.4 μm), ABL-205 (having a particle diameter of 0.2-0.3 μm), and ABL-207 (having a particle diameter of 0.2 μm).

The black iron oxide particles may be surface-coated with inorganic compounds such as SiO₂. Examples of such black iron oxide particles include spherical particles BL-200 (having a particle diameter of 0.2-0.3 μm) and octahedral particles ABL-207A (having a particle diameter of 0.2 μm), each having been surface-coated with SiO₂.

Examples of the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 8-27393, 9-25126, 9-237570, 9-241529 and 10-231441.

The composite metal oxide used in the present invention is preferably a Cu—Cr—Mn system metal oxide or a Cu—Fe—Mn system metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and high light-to-heat conversion efficiency as compared with another metal oxide.

The average primary particle diameter of these composite metal oxides is preferably not more than 1.0 μm, and more preferably 0.01-0.5 μm. The average primary particle diameter of not more than 1.0 μm improves light-to-heat conversion efficiency relative to the addition amount of the particles, and the average primary particle diameter of 0.01-0.5 μm further improves light-to-heat conversion efficiency relative to the addition amount of the particles. The light-to-heat conversion efficiency relative to the addition amount of the particles depends on dispersity of the particles, and the well-dispersed particles exhibit high light-to-heat conversion efficiency. Accordingly, these composite metal oxide particles are preferably dispersed according to a known dispersing method, separately, to obtain a dispersion liquid (paste), before being added to a coating liquid for the layer. In the case of an average primary particle diameter of less than 0.01, dispersing becomes difficult, and this is not preferred. A dispersant is optionally employed for dispersing. The addition amount of the dispersant is preferably 0.01-5% by weight, and more preferably 0.1-2% by weight, based on the weight of the composite metal oxide particles.

### EXAMPLE

Next, the present invention will now be described in detail referring to examples, but the present invention is not limited thereto.

### Example 1

### Preparation of Support

Supports 1-13 were prepared as described below. The surface profile was measured by the following method. The results are shown in Table 1.

### [Measuring Method of Surface Profile]

A platinum-rhodium layer having a thickness of 1.5 nm is vacuum-deposited onto the sample surface, and surface roughness is measured at a magnification of 40 times, employing a non-contact three dimensional surface roughness measuring device RST plus produced by WYKO Co., Ltd., (in which the measurement area is 111.2 μm×149.7 μm, the measuring point is 236×368, and the resolution indicates a size of 0.47 μm×0.41 μm at one measuring point). The resulting measurement is subjected to slope correction and to filtering treatment of Median Smoothing to obtain an Ra value and an Rsk value. Five portions are measured, and the average of the measurements is taken to determine the Ra value and the Rsk value.

### [Support 1]

A 0.24 mm thick aluminum plate (material 1050, refining H16) was immersed in an aqueous 1% by weight sodium hydroxide solution at 50° C. so as to give an aluminum dissolution amount of 2 g/m², washed with water, subsequently immersed in an aqueous 5% by weight nitric acid solution at 25° C. for 30 seconds, and washed with water after neutralization.

Subsequently, the aluminum plate was subjected to an electrolytic surface-roughening treatment in an electrolytic solution containing 11 g/l of hydrochloric acid and 5 g/l of aluminum at a peak current density of 80 A/dm² employing an alternating current with a sine waveform, in which the distance between the plate surface and the electrode was 10 mm. The electrolytic surface-roughening treatment was divided into 8 treatment processes, in which the quantity of electricity used in one treatment process (at a positive polarity) was 50 C/dm², and the total quantity of electricity used (at a positive polarity) was 400 C/dm². Standby time of 4 seconds, during which no surface-roughening treatment was carried out, was provided after each of the treatment processes.

Subsequently, the resulting aluminum plate was immersed in an aqueous 10% by weight phosphoric acid solution at 50° C. and etched so as to give an aluminum dissolution amount (including smut produced on the roughened surface) of 0.65 g/m², and washed with water.

Subsequently, the aluminum plate was subjected to an anodizing treatment in an aqueous 20% by weight sulfuric acid solution at a current density of 4 A/dm² to form an anodization film having a coating amount of 2.5 g/m², and washed with water.

The washed surface of the plate was squeegeed, and the plate was immersed in an aqueous 0.1% by weight disodium trisilicate solution at 30° C. for 15 seconds, washed with water, and dried at 80° C. for 5 minutes to obtain support 1.

### [Support 2]

Support 2 was prepared similarly to preparation of support 1, except that the electrolytic surface-roughening treatment conducted for support 1 was divided into 10 treatment processes, and the total quantity of electricity used (at a positive polarity) was 500 C/dm².

### [Support 3]

Support 3 was prepared similarly to preparation of support 1, except that in the electrolytic surface-roughening treatment conducted for support 1, the electrolytic solution composition was replaced by an electrolytic solution containing 11 g/l of hydrochloric acid, 15 g/l of an acetic acid and 6 g/l of aluminum.

### [Support 4]

Support 4 was prepared similarly to preparation of support 3, except that the electrolytic surface-roughening treatment conducted for support 3 was divided into 6 treatment processes, and the total quantity of electricity was 300 C/dm².

### [Support 5]

Support 5 was prepared similarly to preparation of support 1, except that an aluminum dissolution amount (on the roughened surface) of 0.5 g/m² was made in the phosphoric acid solution for preparation of support 1.

### [Support 6] Comparative Example

Support 6 was prepared similarly to preparation of support 2, except that the electrolytic surface-roughening treatment conducted for support 2 was not divided and was conducted once, and the total quantity of electricity was 500 C/dm².

### [Support 7] Comparative Example

Support 7 was prepared similarly to preparation of support 2, except that the electrolytic surface-roughening treatment conducted for support 3 was not divided and was conducted once, and the total quantity of electricity was 150 C/dm².

### [Support 8] Comparative Example

Support 8 was prepared similarly to preparation of support 7, except that the following mechanical surface-roughening treatment was carried out before conducting the electrolytic surface-roughening treatment for support 7, the electrolytic surface-roughening treatment was divided into 2 treatment processes, the quantity of electricity used in one treatment process (at a positive polarity) was 50 C/dm², and the total quantity of electricity was 100 C/dm².

### Mechanical Surface-Roughening Treatment:

An aqueous slurry with an abrasive (pumice) having an average particle diameter of 10 μm was supplied onto the aluminum plate surface to conduct a mechanical surface-roughening treatment while pressing a nylon brush rotating at 200 rpm against the surface. The treating time during which the nylon brash was brought into contact with the aluminum plate surface was set to 6 seconds. Subsequently, the treated sample was immersed in an aqueous 3% by weight sodium hydroxide solution maintained at 50° C. to conduct a surface-dissolution treatment so as to give a dissolution amount of 2 g/m².

### [Support 9] Comparative Example

Support 9 was prepared similarly to preparation of support 1, except that in the electrolytic surface-roughening treatment conducted for support 1, the electrolytic solution composition was replaced by an electrolytic solution containing 20 g/l of hydrochloric acid, 10 g/l of an acetic acid and 6 g/l of aluminum.

### [Support 10]

Support 10 was prepared similarly to preparation of support 9, except that the electrolytic surface-roughening treatment conducted for support 9 was divided into 10 treatment processes, and the total quantity of electricity used (at a positive polarity) was 500 C/dm².

### [Support 11]

Support 11 was prepared similarly to preparation of support 1, except that in the electrolytic surface-roughening treatment conducted for support 1, the quantity of electricity used in one treatment process (at a positive polarity) was 60 C/dm², and the total quantity of electricity was 480 C/dm².

### [Support 12]

Support 12 was prepared similarly to preparation of support 8, except that the electrolytic surface-roughening treatment conducted for support 8 was divided into 4 treatment processes, and the total quantity of electricity used (at a positive polarity) was 200 C/dm².

### [Support 13]

Support 13 was prepared similarly to preparation of support 3, except that the quantity of electricity used in one treatment process (at a positive polarity) was 150 C/dm², the electrolytic surface-roughening treatment was divided into 3 treatment processes, and the total quantity of electricity used (at a positive polarity) was 450 C/dm².

### [Preparation of Image]

A solid image was prepared on the each of the resulting supports as basic image formation employing oil-based magic ink. The printing area ratio was set to 30%.

### [Printing Method]

Printing was carried out employing a printing press, DAIYA 1F-1 manufactured by Mitsubishi Heavy Industries, Ltd, and employing coated paper, a dampening water, a 2% by weight solution of Astromark 3 (produced by Nikken Kagaku Kenkyusyo Co., Ltd.), and printing ink (TK Hyunity M Magenta, produced by Toyo Ink Manufacturing Co., Ltd.).

Two thousand print copies were continuously printed from the initial stage of printing. Next, the printing evaluation of water retention latitude was made.

### [Evaluation of Resistance to Blanket Contamination]

The extent of blanket contamination after printing 2000 print copies was evaluated by directly measuring magenta density on the blanket surface employing X-Rite, and the results were shown in Table 1. The less the numerical value, the better the resistance to blanket contamination is.

### [Water Retention Latitude]

The emulsification ability via increasing of water was examined through stain-resistance via reduction of water by changing a supply amount of a dampening water to make the following criteria as the water retention latitude.

A: Latitude is broad.

B: Latitude is slightly narrow, but there is no practical problem.

C: Latitude is narrow, and there is a practical problem.

TABLE 1

| | | | Resistance to | | |
|---|---|---|---|---|---|
| | | | blanket | Water | Inv. |
| Support | Ra | | contamination | retention | or |
| No. | (μm) | Rsk | (Magenta density) | latitude | Comp. |
| 1 | 0.39 | −0.20 | 1.10 | A | Inv. |
| 2 | 0.44 | −0.10 | 1.15 | A | Inv. |
| 3 | 0.34 | −0.35 | 0.95 | A | Inv. |
| 4 | 0.28 | −0.60 | 1.00 | B | Inv. |
| 5 | 0.41 | −0.15 | 1.05 | A | Inv. |
| 6 | 0.56 | −1.40 | 1.55 | B | Comp. |
| 7 | 0.22 | −1.00 | 1.25 | C | Comp. |
| 8 | 0.46 | 0.30 | 1.70 | A | Comp. |
| 9 | 0.24 | −0.40 | 0.90 | C | Comp. |
| 10 | 0.27 | −0.15 | 1.10 | B | Inv. |
| 11 | 0.48 | −0.25 | 1.05 | A | Inv. |
| 12 | 0.54 | 0.10 | 1.35 | A | Comp. |
| 13 | 0.37 | −0.95 | 1.40 | C | Comp. |

Inv.: Present invention
Comp.: Comparative example

As is clear from Table 1, it is to be understood that supports for the printing plate material of the present invention exhibit excellent resistance to blanket contamination without deteriorating the other printing performance.

### Example 2

### Preparation of Image Formation Layer

### [Image Formation Layer Coating Solution 1]

The following materials were sufficiently mixed, and filtrated to prepare image formation layer coating solution 1 having a solid content of 5% by weight.

| | |
|---|---|
| Styrene/Acrylic resin particle emulsion | 8.13 parts by weight |
| (a diameter of 100 nm, a Tg of 105° C., | |
| and a solid content of 40% by weight) | |
| Aqueous sodium polyacrylate solution | 12.50 parts by weight |
| (a molecular weight Mw of 1,000,000, | |
| and a solid content of 10% by weight) | |
| Aqueous infrared absorbing solution | 50.00 parts by weight |
| (1% by weight of ADS830WS, produced | |
| by Dye Source Co., Ltd.) | |
| Pure water | 29.37 parts by weight |

### [Preparation of Printing Plate Material Sample]

Above-described image formation layer coating solution was coated on each of supports 1-8 obtained in Example 1 so as to give a dry coating amount of 0.5 g/m², and dried at 50° C. for 3 minutes. After this, an aging treatment was carried out at 40° C. for 24 hours to obtain printing plate material samples 1-13.

### [Exposure to Infrared Laser]

Each of the resulting printing plate samples was wound around an exposure drum. Exposure was carried out employing infrared laser (having a wavelength of 830 nm and a beam spot diameter of 18 μm) at a resolution of 2400 dpi (“dpi” means a dot number per 1 inch, i.e., 2.54 cm) and at a screen line number of 175 to form an image. The image exposed to light includes a dot image with an dot area of 1 to 99%. The exposure energy was set to 300 mJ/cm².

### [Printing Method]

The printing plate material sample exposed to light was mounted on a plate cylinder of a printing press, and printing was carried out similarly to Example 1 to obtain 2000 print copies.

Next, 10,000 print copies was further printed after coated paper was replaced by fine-quality paper (Shiorai).

### [Evaluation of Resistance to Blanket Contamination]

The evaluation was made in the same manner as in Example 1. The results are shown in Table 2.

### [Evaluation of Printing Durability]

The 10,000^{th} print copy printed employing fine-quality paper was visually evaluated, and the criteria of printing durability were made as shown below. The results are shown in Table 2.

A: Neither uneven image density at the solid image portion nor lack of dots at the 3% dot image is observed.

B: Lack of dots at the 3% dot image is partly observed, but no uneven image density at the solid image portion is observed.

C: Uneven image density at the solid image portion is observed.

TABLE 2

| Printing | | | | Resistance | | |
|---|---|---|---|---|---|---|
| plate | | | | to blanket | | |
| material | | | | contamination | Water | Inv. |
| sample | Support | Ra | | (Magenta | retention | or |
| No. | No. | (μm) | Rsk | density) | latitude | Comp. |
| 1 | 1 | 0.39 | −0.20 | 1.15 | A | Inv. |
| 2 | 2 | 0.44 | −0.10 | 1.25 | A | Inv. |
| 3 | 3 | 0.34 | −0.35 | 1.05 | A | Inv. |
| 4 | 4 | 0.28 | −0.60 | 1.05 | B | Inv. |
| 5 | 5 | 0.41 | −0.15 | 1.20 | A | Inv. |
| 6 | 6 | 0.56 | −1.40 | 1.70 | A | Comp. |
| 7 | 7 | 0.22 | −1.00 | 1.30 | C | Comp. |
| 8 | 8 | 0.46 | 0.30 | 1.95 | A | Comp. |
| 9 | 9 | 0.24 | −0.40 | 1.00 | C | Comp. |
| 10 | 10 | 0.27 | −0.15 | 1.15 | A | Inv. |
| 11 | 11 | 0.48 | −0.25 | 1.25 | A | Inv. |
| 12 | 12 | 0.54 | 0.10 | 1.55 | A | Comp. |
| 13 | 13 | 0.37 | −0.95 | 1.50 | C | Comp. |

Inv.: Present invention
Comp.: Comparative example

As is clear from Table 2, it is to be understood that supports for the printing plate material of the present invention exhibit excellent resistance to blanket contamination without deteriorating the other printing performance.

1. A support for a printing plate material comprising an aluminum plate having been subjected to at least a surface-roughening treatment and an anodizing treatment,
wherein the support has a roughened surface having a center-line average roughness Ra of from 0.25 μm to 0.50 μm, and a skewness Rsk of from −0.8 to 0.

2. A printing plate material comprising a support and provided thereon, an on-press developable image formation layer,
wherein the support comprising an aluminum plate having been subjected to at least a surface-roughening treatment and an anodizing treatment has a roughened surface having a center-line average roughness Ra of from 0.25 μm to 0.50 μm, and a skewness Rsk of from −0.8 to 0.

3. The printing plate material of claim 2,
wherein the on-press developable image formation layer comprises an oleophilic polymer particle or a microcapsule encapsulating an oleophilic material.
